(19) United States
(12) Patent Application Publication
(10) Pub. No.: US 2026/0334510 A1
(43) Pub. Date: Oct. 29, 2026

(54) PLANT-BASED FOOD COMPOSITIONS

(71) Applicant: PawCo Foods, Inc., Cupertino, CA (US)

(72) Inventor: Mahsa VAZIN, Cupertino, CA (US)

(73) Assignee: PawCo Foods, Inc., Cupertino, CA (US)

(21) Appl. No.: 19/120,642

(22) PCT Filed: Oct. 6, 2023
(86) PCT No.: PCT/US2023/076286

§ 371 Date: Apr. 11, 2025

Related U.S. Application Data
(60) Provisional application No. 63/416,247, filed on Oct. 14, 2022.

(51) Int. Cl. A23K 10/30; A23J 3/16; A23J 3/22; A23K 10/16; A23K 20/147; A23K 20/174; A23K 20/179; A23K 20/20; A23K 50/42

(52) U.S. Cl. CPC A23K 10/30; A23J 3/16; A23J 3/227; A23K 10/16; A23K 20/147; A23K 20/174; A23K 20/179; A23K 20/30; A23K 50/42

(57) ABSTRACT

Provided are plant-based meat base compositions, plant-based food compositions, and methods of making plant-based food compositions. In some embodiments, a meat base composition comprises a textured protein; a starch binder; water; and optionally a coloring agent. The meat base composition may have a water to textured protein weight ratio of 3:1 to 7:1. The meat base composition has a full amino acid profile, and all components of the composition are plant-based. The composition described herein imparts a meat-like texture and appearance.

### CROSS-REFERENCE TO RELATED APPLICATIONS

This application claims priority to and the benefit of U.S. Provisional Application No. 63/416,247, filed on Oct. 14, 2022, the entire disclosure of which is incorporated herein by reference in its entirety.

### FIELD

The present invention relates to plant-based food products, and specifically, to plant-based food products having a meat base comprising rice, water, and textured protein.

### BACKGROUND

Many traditional diets include animal products (e.g., meat, dairy, eggs) as primary sources of protein and various minerals and vitamins such as iron, zinc, B vitamins, calcium, vitamin A, and vitamin D. However, in recent years, the production of animals for food has been found to cause negative environmental impacts and contribute to climate change. Remarkably, scientists estimate that animal agriculture contributes to approximately 15% of global greenhouse emissions. Additionally, the consumption of animal products has been linked with various health effects, such as cancers, heart disease, diabetes, and autoimmune/inflammatory disorders. Thus, what is needed in the art are alternative meat products, including plant-based meat analogs.

### BRIEF SUMMARY

In some aspects, provided herein are plant-based food compositions, plant-based meat base compositions, and methods of making said compositions. As described above, animal agriculture is a significant contributor to greenhouse gas emissions and climate change, and the consumption of animal products has been linked to numerous diseases and other negative health conditions. The plant-based compositions provided herein have been formulated specifically to provide necessary nutritional value without compromising on flavor or texture. More specifically, the plant-based compositions provided herein comprise a blend of various plant-based proteins that, when combined, provide all twenty amino acids. Further, the plant-based food compositions are produced from a meat base. The meat base is specifically formulated to replicate the texture of a ground beef. Once the meat base is formed, various other ingredients can be added to the meat base to provide all the necessary minerals and vitamins to form a complete nutritional food product.

In some embodiments, the plant-based food compositions described herein may be formulated for human consumption. In some embodiments, the plant-based food compositions described herein may be formulated for animal (e.g., dog, cat, rabbit, horse, goat, pig) consumption. In some embodiments, the plant-based food compositions described herein may be formulated for pet dog consumption. As described above, the plant-based food compositions described herein comprise a plurality of plant-based protein sources. Each of the protein sources comprise a plurality of amino acids, but not all of the amino acids required to achieve a full amino acid profile. When combined, the plurality of plant-based protein sources comprise a full amino acid profile (i.e., arginine, histidine, isoleucine, leucine, lysine, methionine, phenylalanine, threonine, tryptophan, and valine). Additionally, the plant-based food compositions described herein do not comprise any animal-derived products or any animal-derived by-products. In some embodiments, the plant-based food compositions described herein are vegan.

In some embodiments, provided is a meat base composition, the meat base composition comprising: a textured protein; a starch binder; water; and optionally a coloring agent, wherein the meat base composition has a water to textured protein weight ratio of 3:1 to 7:1, wherein the meat base composition has a full amino acid profile, wherein all components of the composition are plant-based, and wherein the composition has a meat-like texture and appearance, or imparts a meat-like texture and appearance to the final food product that incorporates such meat base composition.

In some embodiments of the meat base composition, the starch binder comprises cooked rice. In some embodiments of the meat base composition, a weight ratio of starch binder to water is at least 1:30. In some embodiments of the meat base composition, the meat base composition comprises at least 2 wt. % starch binder. In some embodiments of the meat base composition, the meat base composition comprises 1-3 wt. % coloring agent. In some embodiments of the meat base composition, the coloring agent comprises beet root powder. In some embodiments of the meat base composition, the meat base composition comprises 5-15 wt. % textured protein. In some embodiments of the meat base composition, the textured protein is textured soy protein.

In some embodiments, provided is a food composition, the food composition comprising: the meat base composition of as provided herein; and at least one additional component that adds flavor and/or aroma to the food composition. In some embodiments of the food composition, the food composition comprises 70-80 wt. % meat base composition. In some embodiments of the food composition, the meat base composition imparts a meat-like property to the food composition that incorporates such meat base composition. In some embodiments of the food composition, the food composition has a nutritional profile that provides a complete and balanced petfood diet as defined by AAFCO. In some embodiments of the food composition, the food composition has an amino acid profile comprising essential amino acids. In some embodiments of the food composition, the food composition comprises at least one additional protein. In some embodiments of the food composition, the at least one additional protein comprises at least one of yeast protein or pea protein. In some embodiments of the food composition, the food composition comprises 5-10 wt. % yeast protein. In some embodiments of the food composition, the food compositions comprises 1-5 wt. % pea protein. In some embodiments of the food composition, the food composition comprises both yeast protein and pea protein, wherein a weight ratio of the yeast protein to the pea protein is from 5:2 to 3:1. In some embodiments of the food composition, the food composition comprises both yeast protein and pea protein, wherein a weight ratio of the textured protein to a total amount of the yeast protein and the pea protein is from 1:1 to 3:2.

In some embodiments of the food composition, the food composition comprises at least one additional source of essential vitamins, essential minerals, or a combination thereof. In some embodiments of the food composition, the food composition comprises at least one additional fiber source. In some embodiments of the food composition, the food composition comprises at least one additional antioxidant and/or preservative. In some embodiments of the food composition, the food composition is a petfood composition. In some embodiments of the food composition, the food composition has a shelf-life of 3-10 days refrigerated.

In some embodiments, provided is a method of making a plant-based food composition, the method comprising: mixing water, coloring agent, a starch binder, and textured soy protein to form meat base; mixing in additional plant-based protein; mixing in palatant; mixing in vitamins and minerals; mixing in oil and preservative. In some embodiments of the method, the method comprises mixing in flavoring agent. In some embodiments of the method, the method comprises setting aside the food composition under controlled temperature for further hydration. In some embodiments, the method further comprises cooking the composition to remove about 40 wt. % to about 95 wt. %, such as about 60 wt. % to about 90 wt. % water from the composition.

In one aspect, provided herein is a dehydrated plant-based food composition, comprising: a textured protein; a starch binder; water; optionally a coloring agent; and at least one additional component that adds flavor and/or aroma to the food composition; wherein the weight percentage of water in the composition is no more than 30%, such as no more than any of 20%, 15%, 10%, or 5%; wherein the composition has a full amino acid profile; wherein all components of the composition are plant-based; and when the composition is rehydrated, the rehydrated composition has or imparts a meat-like texture and appearance. In some embodiments, provided herein is a dehydrated plant-based food composition, prepared by cooking the plant-based food composition provided herein to remove about 60 wt. % to about 90 wt. % water from the plant-based food composition.

### BRIEF DESCRIPTION OF DRAWINGS

The present application can be understood by reference to the following description taken in conjunction with the accompanying figures.

FIG. 1 is a flow diagram depicting a method of making a plant-based food composition, according to some embodiments; and

FIG. 2 shows palatability test data.

### DETAILED DESCRIPTION

The following description sets forth exemplary systems, methods, parameters and the like. It should be recognized, however, that such description is not intended as a limitation on the scope of the present disclosure but is instead provided as a description of exemplary embodiments.

In some aspects, provided herein are plant-based food compositions, plant-based meat base compositions, and methods of making said compositions. The plant-based food compositions described herein comprise a full amino acid profile provided by a plurality of plant-based protein sources. As used herein, a full amino acid profile includes the following ten amino acids: arginine, histidine, isoleucine, leucine, lysine, methionine, phenylalanine, threonine, tryptophan, and valine. No animal-derived products or animal-derived by-products are included in the plant-based food compositions described herein.

As described above, animal agriculture has been recognized as generating greenhouse gas emissions and contributing to climate change. Further, the consumption of animal products has been associated with various diseases and other health conditions. Accordingly, there has been increased interest in recent years to replace animal products with plant-based products in the diet without compromising nutrition, flavor, or texture.

In some embodiments, the plant-based food compositions and plant-based meat base compositions described herein are specifically formulated for human consumption. In some embodiments, the plant-based food compositions and plant-based meat base compositions described herein are specifically formulated for animal consumption (e.g., dog, cat, hamster, horse, pig, rabbit, goat). In some embodiments, the plant-based food compositions and plant-based meat base compositions described herein are specifically formulated for pet dogs.

In some variations of the foregoing, the plant-based food compositions and plant-based meat base compositions described herein are “fresh”. As used herein, “fresh” food, or in one variation, fresh petfood, refers to a composition that (i) has moisture, and (ii) needs to be refrigerated or frozen. In certain variations, the fresh plant-based food compositions and plant-based meat base compositions have a moisture content of at least about 15%, such as at least about any of 20%, 25%, 30%, 35%, 40%, 45%, 50%, 55%, or 60%. For example, it should be understood that fresh petfood excludes dried kibble products.

Described below are plant-based meat base compositions and final plant-based food compositions according to embodiments described herein. The plant-based compositions described herein are specifically formulated to replicate the texture and look of ground beef. The plant-based compositions may include: (1) a plant-based meat base composition, and (2) a final plant-based meat product, which is produced from the meat base described herein and be either be in the form of (a) a wet product or a dehydrated product that needs to be rehydrated prior to consumption by the subject so as to form the meat-like texture. In each of the embodiments of the compositions described above, the compositions are “fresh” as described above. In the case of the dehydrated plant-based food composition, the product is considered fresh when the water/moisture is added to the product prior to consumption by the subject.

### Plant-Based Meat Base Compositions

In some embodiments, plant-based meat base compositions comprise rice, textured protein, a coloring agent, and water.

Plant-based meat base compositions according to embodiments described herein comprise cooked rice. The cooked rice can help achieve the desired texture and appearance of the meat base composition (i.e., resembling ground meat). The cooked rice can also aid in the user's digestion. Further, in some cases, when an animal switches food, it can cause gastroenteritis. However, the presence of cooked rice in the plant-based meat base composition can help mitigate the symptoms of gastroenteritis, particularly in plant-based food compositions formulated for dog consumption.

In some embodiments, a plant-based meat base composition may comprise 1-5 wt. % starch binder. In some embodiments, a plant-based meat base composition may comprise less than or equal to 5, 4, 3, or 2 wt. % starch binder. In some embodiments, a plant-based meat base composition may comprise greater than or equal to 1, 2, 3, or 4 wt. % starch binder. In some embodiments, the plant-based meat base composition comprises a minimum of 1.95 wt. % starch binder. The starch binder may comprise cooked rice, wheat, maize, corn, potato starch, cassava, or peas. Cooked rice may be cooked by using methods such as parboiling, boiling, or steaming.

Plant-based meat base compositions according to embodiments described herein comprise textured protein. Textured protein is just one source of plant-based protein in the plant-based food composition and thus, provides some of the essential amino acids. Textured protein is a defatted soy flour product a by-product of extracting soybean oil. In some embodiments, a plant-based meat base composition may comprise 10-25 wt. % textured protein. In some embodiments, a plant-based meat base composition may comprise less than or equal to 25, 20, or 15 wt. % textured protein. In some embodiments, a plant-based meat base composition may comprise greater than or equal to 10, 15, or 20 wt. % textured protein.

Plant-based meat base compositions according to embodiments described herein comprise water. The water provides moisture and allows the powders (e.g., protein powders) and other dry ingredients of the plant-based food composition to dissolve. Further, some of the water is absorbed by the cooked rice, which helps contribute to the texture and appearance of the meat base. In some embodiments, a plant-based meat base composition may comprise 70-90 wt. % water. In some embodiments, a plant-based meat base composition may comprise less than or equal to 90, 85, 80, or 75 wt. % water. In some embodiments, a plant-based meat base composition may comprise greater than or equal to 70, 75, 80, or 85 wt. % water.

In some embodiments, a plant-based meat base composition comprises water and textured protein in a weight ratio of 3:1 to 9:1, 3:1 to 7:1, or 5:1 to 6:1. In some embodiments, a weight ratio of water to textured protein is less than or equal to 9:1, 8:1, 7:1, 6:1, 5:1, or 4:1. In some embodiments, a weight ratio of water to textured protein is greater than or equal to 3:1, 4:1, 5:1, 6:1, 7:1, or 8:1.

In some embodiments, a plant-based meat base composition comprises water and starch binder in a weight ratio of 20:1 to 70:1 or at least 30:1. In some embodiments, a weight ratio of water to starch binder is less than or equal to 70:1, 60:1, 50:1, 40:1, or 30:1. In some embodiments, a weight ratio of water to starch binder is greater than or equal to 20:1, 30:1, 40:1, 50:1, or 60:1.

Plant-based meat base compositions according to embodiments described herein may comprise a coloring agent to help replicate the appearance of ground beef. For example, many meat products, including ground beef, can be brown and/or red. Thus, a coloring agent may be used to more align the color of the meat base with that of ground beef. In some embodiments, the coloring agent is a natural coloring agent. In some embodiments, a plant-based meat base composition may comprise 1-4 wt. % coloring agent. In some embodiments, a plant-based meat base composition may comprise less than or equal to 4, 3, or 2 wt. % coloring agent. In some embodiments, a plant-based meat base composition may comprise greater than or equal to 1, 2, or 3 wt. % coloring agent. Suitable coloring agents can include beet root powder, radishes, dried hibiscus flowers, cranberries, pomegranate powder, etc.

For example, in one aspect, provided is a plant-based meat base composition, comprising parboiled rice, a textured protein, water and beet root. In some variations, the parboiled rice is parboiled white rice. In some variations, the textured protein is textured soy protein. In some variations, the beet root is ground and/or provided in powder form. In some variations of the foregoing, the composition has up to 85% by weight water.

### Final Plant-Based Food Compositions

The final plant-based food compositions described herein comprise the plant-based meat base composition described immediately above, in addition to a plurality of additives such as vitamins, minerals, oils, etc. described below. The additives described herein are used to achieve a targeted nutritional profile. For example, if formulated for human consumption, the plant-based food composition can include a nutrition profile consistent with that which is outlined by the U.S. Food and Drug Administration (FDA). If formulated for animal consumption, the plant-based food composition can include a nutrition profile consistent with that which is outlined by the Association of American Feed Control Officials (AAFCO). If formulated for specifically dog or cat consumption, the plant-based food composition may be “complete and balanced” as defined by AAFCO.

As described above, plant-based food compositions described herein comprise and are produced from the plant-based meat base composition. Generally, two categories of plant-based food compositions may be produced from the plant-based meat base compositions described above: a wet product, and a dehydrated product that needs to be rehydrated prior to consumption by the subject to restore its meat-like texture. The dehydrated product may be produced by further removing some or most of the water from the composition during the cooking process. The water can be added back to rehydrate the composition right before serving the composition to the subject.

The plant-based meat base composition imparts a meat-like property to the final plant-based food composition. It should be understood that, in the case of the dehydrated product, the rehydrated form will have a meat-like property once water/moisture is added to the dehydrated product. For example, in some embodiments, the plant-based meat base composition may provide texture or an appearance of meat (e.g., ground meat) to the plant-based food composition, e.g., the wet product or the rehydrated form of the dehydrated product. In some embodiments, a plant-based food composition according to embodiments described herein may comprise 50-85 wt. % plant-based meat base composition. In some embodiments, a plant-based food composition may comprise less than or equal to 85, 80, 75, 70, 65, 60, or 55 wt. % plant-based meat base composition. In some embodiments, a plant-based food composition may comprise greater than or equal to 50, 55, 60, 65, 70, or 75 wt. % plant-based meat base composition.

As described above, the plant-based meat base composition may comprise starch binder, textured protein, water, and coloring agent. The plant-based food composition described herein may comprise 1-5 wt. % starch binder. The plant-based meat base composition described herein may comprise 1-5 wt. % starch binder. In some embodiments, the plant-based food composition may comprise less than or equal to 5, 4, 3, or 2 wt. % starch binder. In some embodiments, the plant-based meat base composition may comprise less than or equal to 5, 4, 3, or 2 wt. % starch binder. In some embodiment, the plant-based food composition may comprise greater than or equal to 1, 2, 3, or 4 wt. % starch binder. In some embodiment, the plant-based meat base composition may comprise greater than or equal to 1, 2, 3, or 4 wt. % starch binder.

In some embodiments, the plant-based food composition may comprise 5-20 wt. % textured protein. In some embodiments, the plant-based food composition may comprise less than or equal to 20, 15, or 10 wt. % textured protein. In some embodiments, the plant-based food composition may comprise greater than or equal to 5, 10, or 15 wt. % textured protein. In some embodiments, the plant-based meat base composition may comprise 5-20 wt. % textured protein. In some embodiments, the plant-based meat base composition may comprise less than or equal to 20, 15, or 10 wt. % textured protein. In some embodiments, the plant-based meat base composition may comprise greater than or equal to 5, 10, or 15 wt. % textured protein. Suitable examples of textured protein include, but are not limited to, textured vegetable protein, textured soy protein, or textured pea protein. In some embodiments, the texturized protein includes textured plant protein. In some embodiments, the texturized protein includes mushroom protein.

In the case of the wet plant-based food composition or the rehydrated form of the dehydrated plant-based food composition, in some embodiments, the composition may comprise 50-80 wt. % water. In some embodiments, the plant-based food composition may comprise less than or equal to 80, 75, 70, 65, 60, or 55 wt. % water. In some embodiments, the plant-based food composition may comprise greater than or equal to 50, 55, 60, 65, 70, or 75 wt. % water.

It should be understood that the dehydrated plant-based food composition is the form that is typically sold to consumers, and consumers need to rehydrate the dehydrated composition. In some embodiments, the dehydrated plant-based food composition has less than 30%, such as less than about any of 20%, 15%, or 10% water.

In some embodiments, the plant-based food composition may comprise 0.5-5 wt. % coloring agent. In some embodiments, the plant-based food composition may comprise less than or equal to 5, 4, 3, 2, or 1 wt. % coloring agent. In some embodiments, the plant-based food composition may comprise greater than or equal to 0.5, 1, 2, 3, or 4 wt. % coloring agent.

In addition to the plant-based meat base composition, the plant-based food compositions described herein comprise a variety of additional protein sources, vitamins, minerals, and other additives. Each of these additional ingredients is described in detail below.

As described above, because the plant-based food compositions described herein do not include any animal-derived products, two or more plant-based protein sources are included to ensure a full amino acid profile (i.e., the presence of all twenty amino acids). Unlike animal-derived sources of protein, no single plant-based protein source comprises all twenty amino acids. Thus, a plurality of plant-based protein sources are included in the plant-based food compositions provided herein, wherein each plant-based protein source includes a plurality of amino acids, and all twenty amino acids are present in the plurality of plant-based amino acids.

In some embodiments, a plant-based food composition may comprise 5-20 wt. % plant-based protein in addition to the TSP of the plant-based meat base composition. In some embodiments, a plant-based food composition may comprise less than or equal to 20, 15, or 10 wt. % plant-based protein in addition to the TSP of the plant-based meat base composition. In some embodiments, a plant-based food composition may comprise greater than or equal to 5, 10, or 15 wt. % plant-based protein in addition to the TSP of the plant-based meat base composition. In some embodiments, the plant-based proteins included in the plant-based food composition (in addition to the TSP of the plant-based meat base composition) may include yeast protein, pea protein, soy protein, mung bean, pea protein, hemp protein, pumpkin seed protein, brown rice protein, sunflower seed protein, sacha inchi protein, or chia protein. In some embodiments, the plant-based proteins included in the plant-based food composition (in addition to the TSP of the plant-based meat base composition) may include mushroom protein.

In some embodiments, a plant-based food composition comprises both yeast protein and pea protein in a weight ratio of the yeast protein to the pea protein is from 5:1 to 1:1 or 5:3 to 3:1. In some embodiments, a weight ratio of the yeast protein to the pea protein is less than or equal to 5:1, 4:1, 3:1, 5:2, 2:1, or 3:2. In some embodiments, a weight ratio of the yeast protein to the pea protein is greater than or equal to 3:2, 2:1, 5:2, 3:1, or 4:1.

In some embodiments, a plant-based food composition comprises both yeast protein and pea protein, and a weight ratio of the textured protein to a total amount of the yeast protein and the pea protein is from 1:3 to 3:1 or 1:1 to 3:2. In some embodiments, a weight ratio of the textured protein to a total amount of the yeast protein and the pea protein is less than or equal to 3:1, 5:2, 2:1, 3:2, 1:1, 4:5, 3:5, or 1:2. In some embodiments, a weight ratio of the textured protein to a total amount of the yeast protein and the pea protein is greater than or equal to 1:3, 1:2, 3:5, 4:5, 1:1, 3:2, 2:1, or 5:2.

The plant-based food compositions described herein may also include one or more vitamins. In some embodiments, a plant-based food composition may comprise 0.01-3 wt. % one or more vitamins. In some embodiments, a plant-based food composition may comprise less than or equal to 3, 2, 1, or 0.1 wt. % one or more vitamins. In some embodiments, a plant-based food composition may comprise greater than or equal to 0.01, 0.1, 1, or 2 wt. % one or more vitamins. The one or more vitamins may include, but are not limited to, retinol (vitamin A), beta-carotene (vitamin A), riboflavin (vitamin B2), niacin (vitamin B3), pyridoxine as pyridoxine HCl (vitamin B6), cobalamin (vitamin B12), vitamin D2 (ergocalciferol), vitamin D3 (cholecalciferol), vitamin E (alpha-tocopherol), vitamin E (beta-tocopherol), vitamin E (gamma-tocopherol), vitamin E (delta-tocopherol). In some embodiments, the one or more vitamins may include a vitamin supplement. For example, in cases in which the plant-based food composition is formulated for dog consumption, a suitable vitamin supplement may include Vitamins DOG, (NSADCMP), which is a vitamin mix made from plant-based sources.

Plant-based food compositions provided herein may also include a plurality of mineral sources. In some embodiments, a plant-based food composition may comprise 0.01-3 wt. % mineral sources. In some embodiments, a plant-based food composition may comprise less than or equal to 3, 2, 1, or 0.1 wt. % mineral sources. In some embodiments, a plant-based food composition may comprise greater than or equal to 0.01, 0.1, 1, or 2 wt. % mineral sources. Suitable mineral sources may include, but are not limited to, ammonium chloride, ammonium sulfate, choline chloride, tricalcium phosphate, calcium carbonate, calcium chloride, calcium sulfate, iron carbonate, sodium chloride, zinc proteinate, sodium selenite, magnesium sulfate, magnesium oxide, monosodium phosphate, selenium yeast, potassium chloride, potassium sulfate, potassium iodide, zinc sulfate/zinc proteinate, zinc oxide, zinc sulfate, copper oxide, copper sulfate, copper proteinate, and iron proteinate.

Plant-based food compositions provided herein may also include a plurality of mineral sources, wherein the selection of the mineral sources can vary to satisfy different needs and provide various health benefits. For example, one or more mineral sources are selected to include in the plant-based food composition to meet the need of senior people or animals. In some embodiments, one or more mineral sources are selected to include in the plant-based food composition to improve joint health. In some embodiments, one or more mineral sources are selected to include in the plant-based food composition to improve hair/fur health.

Fats/oils may also be included in the plant-based food compositions described herein. In some embodiments, a plant-based food composition may comprise 1-15 wt. % fats/oils. In some embodiments, a plant-based food composition may comprise less than or equal to 15, 10, or 5 wt. % fats/oils. In some embodiments, a plant-based food composition may comprise greater than or equal to 1, 5, or 10 wt. % fats/oils. Suitable fats/oils may include, but are not limited to, sunflower oil, peanut butter, olive oil, canola oil, vegetable oil, coconut oil, palm oil, corn oil, soybean oil, sesame oil, etc. Oils can also be mixed with lecithin to form a fat emulsion, and added to the composition as a fat emulsion.

An edible fiber source may also be included in the plant-based food compositions described herein to improve digestion. In some embodiments, a plant-based food composition may comprise 1-10 wt. % fiber source. In some embodiments, a plant-based food composition may comprise less than or equal to 10, 8, 6, 4, or 2 wt. % fiber source. In some embodiments, a plant-based food composition may comprise greater than or equal to 1, 2, 4, 6, or 8 wt. % fiber source. Suitable fiber sources may include, but are not limited to, cranberries, peas, carrots, and broccoli.

A preservative may be included in a plant-based food composition to improve the shelf life of the product. In some embodiments, a plant-based food composition may include 0.01-2 wt. % preservative. In some embodiments, a plant-based food composition may include less than or equal to 2, 1, 0.5, 0.1, or 0.5 wt. % preservative. In some embodiments, a plant-based food composition may comprise greater than or equal to 0.01, 0.05, 0.1, 0.5, or 1 wt. % preservative. A suitable preservative can include, but is not limited to, Naturox® IP, which is a blend of rosemary and mixed tocopherols.

Additional additives to improve the flavor and aroma of the plant-based food compositions may also be included. For example, a plant-based food composition may comprise 0.5-5 wt. % flavoring agents. In some embodiments, a plant-based food composition may comprise less than or equal to 5, 4, 3, 2, or 1 wt. % flavoring agents. In some embodiments, a plant-based food composition may comprise greater than or equal to 0.5, 1, 2, 3, or 4 wt. % flavoring agent. Suitable flavoring agents may include, but are not limited to, a palatant (e.g., Shade 100802) and one or more spices or herbs.

Other additives can be included in the plant-based food compositions described herein. For example, additional additives can provide further nutritional value (e.g., minerals, vitamins), a digestive aid (e.g., Lactospore Probiotics, 15B), and other flavor/aroma enhancers. For example, additional additives can further include flaxseed and/or dried kelp.

In some embodiments, the shelf life of the plant-based food composition is 6-36 months, 6-24 months, or 9-12 months frozen. In some embodiments, the shelf life of the plant-based food composition is less than or equal to 36, 30, 24, 18, 12, or 9 months frozen. In some embodiments, the shelf life of the plant-based food composition is greater than or equal to 6, 9, 12, 18, 24, or 30 months frozen. In some embodiments, the shelf life of the plant-based food composition is 2-60 days, 3-30 days, or 3-10 days refrigerated. In some embodiments, the shelf life of the plant-based food composition is less than or equal to 60 days, 50 days, 40 days, 30 days, 20 days, 10 days, 8 days, 7 days, 6 days, 5 days, 4, days, or 3 days refrigerated. In some embodiments, the shelf life of the plant-based food composition is greater than or equal to 2 days, 3 days, 4 days, 5 days, 6 days, 7 days, 8 days, 10 days, 20 days, 30 days, 40 days, or 50 days refrigerated.

In some embodiments, the shelf life of the plant-based food composition is 1-120 hours, 2-100 hours, 2-50 hours, or 3-8 hours under room temperature. In some embodiments, the shelf life of the plant-based food composition is less than or equal to 120 hours, 100 hours, 80 hours, 60 hours, 40 hours, 20 hours, 17 hours, 15 hours, 13 hours, 10 hours, 8 hours, 7 hours, 6 hours, 5 hours, 4 hours, 3 hours, or 2 hours under room temperature. In some embodiments, the shelf life of the plant-based food composition is greater than or equal to 1 hour, 2 hours, 3 hours, 4 hours, 5 hours, 6 hours, 7 hours, 8 hours, 10 hours, 13 hours, 15 hours, 17 hours, 20 hours, 40 hours, 60 hours, 80 hours, or 100 hours under room temperature.

In some embodiments, the shelf life of the dehydrated product of the plant-based food composition is at least about 1 year, such as about 1 year to 10 years, about 1 year to 5 years, or about 2 years to 5 years under room temperature. In some embodiments, the shelf life of the dehydrated product of the plant-based food composition is less than or equal to about any of 10, 8, 6, 5, 4, or 3 years under room temperature. In some embodiments, the shelf life of the dehydrated product of the plant-based food composition is greater than or equal to about any of 1, 1.5, or 2 years under room temperature. In some embodiments, the dehydrated product of the plant-based food composition can be packed under vacuum. In some embodiments, the dehydrated product of the plant-based food composition can be packed under inert gas.

In some embodiments, the pH value of the plant-based food composition is about 5 to about 9, about 6 to about 8, or about 7. In some embodiments, the pH of the plant-based food composition is less than or equal to 9, 8.5, 8, 7.5, 7, 6.5, or 6. In some embodiments, the pH of the plant-based food composition is greater than or equal to 5, 5.5, 6, 6.5, 7, 7.5, or 8. In some embodiments, the pH of the plant-food composition may help with maintaining the shelf-life of the plant-food composition. In some embodiments, the pH of the plant-food composition may help with maintaining the function of the textured protein. In some embodiments, the plant-food composition has a pH value that is suitable to maintain the shelf-life of the plant-based food composition and the function of the textured protein, wherein the pH value is about 7.

In some embodiments, the plant-based food compositions provided herein may also comprise a probiotic. In some embodiments, the probiotic comprises aerobic lactic acid bacteria. In some embodiments, the probiotic comprises anaerobic lactic acid bacteria. In some embodiments, the probiotics may help with the digestion of plant-food compositions. In some embodiments, the probiotics may help with animals to digest high-protein food compositions. In some embodiments, the probiotics may help with the digestion of plant-based and high-protein food compositions.

Table 1, below, shows an exemplary composition of a plant-based food composition, according to some embodiments. It should be understood that in view of the wt. % provided in the table, the components should not exceed 100 wt. %.

TABLE 1
Exemplary plant-based food composition

| Formula | | |
|---|---|---|
| Components | Ingredient Name | Wt. (%) |
| Meat Analog | Water | 60-80 |
| | Textured soy protein (TVP) | 5-15 |
| | Rice - Parboiled | 1-5 |
| | Beet Root, Ground | 1-5 |
| Protein + vitamin & | Examples: yeast protein, pea | 1-20 |
| mineral solutions | protein, berries, flaxseed, | |
| | kelp probiotics | |
| Fat | Examples: peanut butter, | 0.05-10 |
| | sunflower oil | |
| Flavor additives | Examples: palatant, spice | 0.1-5 |

### Methods of Preparing Plant-Based Meat Base Compositions and Plant-Based Food Compositions

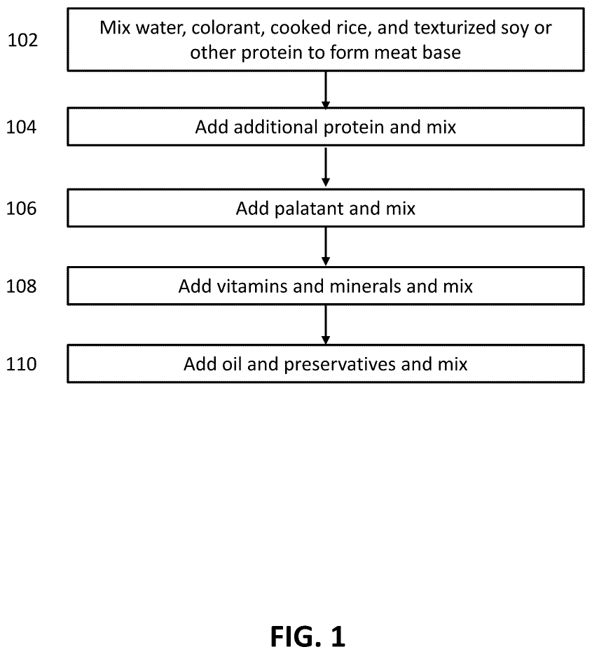

FIG. 1 is a flow diagram depicting an exemplary method of making a plant-based food composition, according to some embodiments. At step 102, the ingredients for the plant-based meat base, including water, a coloring agent, a starch binder, and texturized protein (e.g., texturized soy proteins) are mixed. In other embodiments, other sources of textured protein may be used in place or in combination with soy textured proteins.

In some embodiments of step 102, when the texturized protein (e.g., texturized soy proteins) is mixed into an already formed mixture, the mixing process further comprises hydrating the textured soy protein between each mixing cycle. In other embodiments, other sources of textured protein may be used in place or in combination with soy texturized proteins.

At step 104, a protein enrichment solution is added to and mixed with the meat base.

At step 106, one or more palatants is added and mixed.

At step 110, one or more oils and one or more preservatives are added to and thoroughly mixed. In some embodiments, the final mixture at step 110 is set aside under controlled temperature for further hydration and/or incubation.

It should be understood that, in other exemplary embodiments of the method, steps 102, 104, 106, 108, and 110 may be performed in different orders. For example, in some embodiments, step 102 is immediately followed by step 104. In some embodiments, step 104 is immediately followed by step 102. In some embodiments, step 102 is immediately followed by step 106. In some embodiments, step 106 is immediately followed by step 102. In some embodiments, step 102 is immediately followed by step 108. In some embodiments, step 108 is immediately followed by step 102. In some embodiments, step 102 is immediately followed by step 110. In some embodiments, step 110 is immediately followed by step 102. In some embodiments, step 104 is immediately followed by step 106. In some embodiments, step 106 is immediately followed by step 104. In some embodiments, step 104 is immediately followed by step 108. In some embodiments, step 108 is immediately followed by step 104. In some embodiments, step 104 is immediately followed by step 110. In some embodiments, step 110 is immediately followed by step 104. In some embodiments, step 106 is immediately followed by step 108. In some embodiments, step 108 is immediately followed by step 106. In some embodiments, step 106 is immediately followed by step 110. In some embodiments, step 110 is immediately followed by step 106. In some embodiments, step 106 is immediately followed by step 110. In some embodiments, step 110 is immediately followed by step 106. In some embodiments, step 108 is immediately followed by step 110. In some embodiments, step 110 is immediately followed by step 108.

In some embodiments, the plant-based food composition described herein may be further dehydrated. In some embodiments, the dehydration can be carried out at low temperature, such as a temperature below about 80 °C, 70 °C, 60 °C, 50 °C, or 40 °C. In some embodiments, the dehydration can be carried out with minimal processing such that the dehydrated product can be rehydrated and form the meat-like appearance and texture.

### EXAMPLES

### Example 1. Preparation of a Plant-Based Food Composition

A meat juice was first prepared by mixing water and natural food coloring. Then the meat juice was mixed with cooked rice and textured vegetable protein (e.g., textured soy protein). The mixture was thoroughly mixed, and then set aside for hydration. The same mixing and hydration cycle was repeated to form the meat base.

### Example 2. Palatability Test of a Plant-Based Food Composition

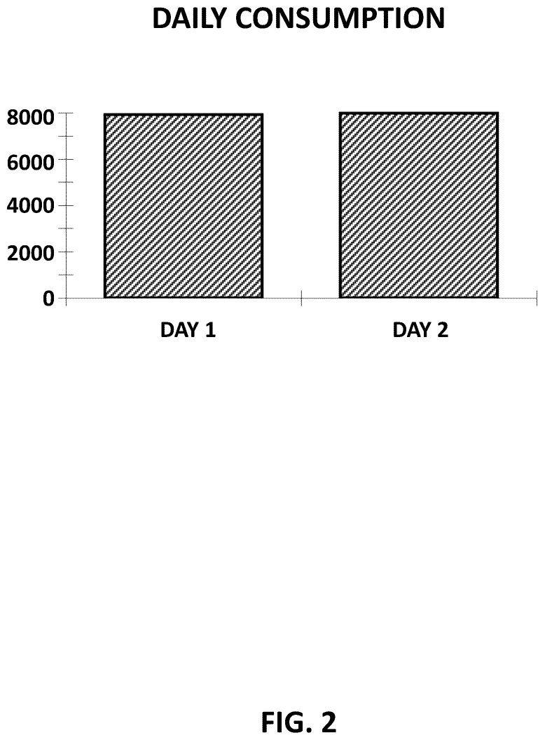

A plant-based food composition prepared in accordance with the method provided in Example 1 above was tested for palatability. Twenty dogs normally on animal-based diets consumed the plant-based food composition. Table 2 below shows twenty dogs' consumption of the plant-based food composition on day 1 and day 2. FIG. 2 shows the total consumption of the plant-based food composition on day 1 and day 2.

TABLE 2
Consumption of the plant-based food composition

| | Dog | Day 1 | Day 2 |
|---|---|---|---|
| Dog # | Weight (kg) | Consumption (g) | Consumption (g) |
| 1 | 11.6 | 400 | 400 |
| 2 | 13.0 | 400 | 400 |
| 3 | 12.3 | 400 | 400 |
| 4 | 11.7 | 400 | 400 |
| 5 | 14.1 | 341 | 400 |
| 6 | 9.0 | 400 | 400 |
| 7 | 12.1 | 400 | 400 |
| 8 | 9.1 | 400 | 400 |
| 9 | 10.9 | 400 | 400 |
| 10 | 14.7 | 400 | 400 |
| 11 | 18.5 | 400 | 400 |
| 12 | 13.0 | 400 | 400 |
| 13 | 11.0 | 400 | 400 |
| 14 | 11.4 | 400 | 400 |
| 15 | 11.8 | 400 | 400 |
| 16 | 26.1 | 391 | 400 |
| 17 | 13.7 | 400 | 400 |
| 18 | 10.9 | 400 | 400 |
| 19 | 21.0 | 400 | 400 |
| 20 | 20.0 | 400 | 400 |

| | | |
|---|---|---|
| Total | 7932 | 8000 |

As shown in Table 2 and FIG. 2 dogs consumed 99% of the food on day 1 and consumed 100% of the food on day 2. It is commonly seen that day 2 shows the experience the dogs had with the product. In this test, the dogs had a higher consumption of the product suggesting they enjoyed the taste and experience. They also had no gastro-intestinal upset.

### Example 3. Compositional Analysis of Plant-Based Food Composition

A plant-based food composition prepared in accordance with the method provided in Example 1 above was analyzed. The analysis is shown in Table 3.

TABLE 3
Composition of a plant-based food composition

| | Level Found | | |
|---|---|---|---|
| | As | Dry | |
| Component | Received | Weight | Units |
| Moisture (canned) | 50-80 | | % |
| Protein (crude) | 10-20 | 30-100 | % |
| Fat (acid hydrolysis) | 1-20 | 1-20 | % |
| Fiber (crude) | 1-10 | 1-20 | % |
| Phosphorus (total) | 0.1-5 | 1-10 | % |
| Calcium (total) | 0.1-5 | 1-10 | % |
| Sodium (total) | 0.1-5 | 0.1-1 | % |
| Iron (total) | 10-100 | 50-200 | ppm |
| Manganese (total) | 10-100 | 10-100 | ppm |
| Copper (total) | 1-10 | 5-15 | ppm |
| Zinc (total) | 10-100 | 100-200 | ppm |
| Chloride | 0.1-5 | 0.1-5 | % |
| Iodine (total) | 0.1-5 | 1-10 | ppm |
| Selenium (total) | <0.10 | <0.10 | ppm |
| Alanine | 0.01-5 | 1-5 | % |
| Arginine | 0.01-5 | 1-5 | % |
| Aspartic acid | 0.01-5 | 1-5 | % |
| Cystine | 0.01-5 | 0.01-5 | % |
| Glutamic acid | 0.01-5 | 1-5 | % |
| Glycine | 0.01-5 | 1-5 | % |
| Histidine | 0.01-5 | 1-5 | % |
| Isoleucine | 0.01-5 | 1-5 | % |
| Leucine | 0.01-5 | 1-5 | % |
| Lysine (total) | 0.01-5 | 1-5 | % |
| Methionine | 0.01-5 | 0.01-5 | % |
| Phenylalanine | 0.01-5 | 1-5 | % |
| Proline | 0.01-5 | 1-5 | % |
| Serine | 0.01-5 | 1-5 | % |
| Threonine | 0.01-5 | 1-5 | % |
| Tyrosine | 0.01-5 | 1-5 | % |
| Tryptophan | 0.01-5 | 0.01-5 | % |
| Valine | 0.01-5 | 1-5 | % |
| Vitamin A (total) | 500-1000 | 1500-2500 | IU/100 g |
| Thiamine as Thiamine | 1-30 | 30.0-60 | mg/kg |
| Hydrochloride | | | |
| Vitamin B2 | 1-20 | 10-40 | mg/kg |
| Vitamin B3 | 10-40 | 50-100 | mg/kg |
| Choline chloride | 1000-1500 | 3000-4000 | mg/kg |
| Vitamin B6 | 1-10 | 5-15 | mg/kg |
| Folic acid | 1-5 | 2-5 | mg/kg |
| Vitamin B12 | 0.01-5 | 0.01-5 | mg/kg |
| Vitamin D2 | 100-500 | 500-1000 | IU/kg |
| Vitamin E (total) | 100-500 | 300-600 | IU/kg |
| Lactic acid bacteria | >600000 | | cfu/g |
| (aerobic) | | | |
| Lactic acid bacteria | >600000 | | cfu/g |
| (anaerobic) | | | |
| Aerobic plate count | 310 | | cfu/g |
| E. coli (generic) | <10 | | cfu/g |
| Total coliforms | <10 | | cfu/g |
| Yeast | <10 | | cfu/g |
| Mold count | <10 | | cfu/g |
| Staphylococcus aureus | <10 | | cfu/g |
| Salmonella | negative | | org/25 g |
| Listeria | negative | | org/25 g |

* cfu = colony forming unit
** ppm = parts per million
*** Mineral analysis performed by ICAP using a wet digest procedure

1. A meat base composition, comprising:
a textured protein;
a starch binder;
water; and
optionally a coloring agent,
wherein the meat base composition has a water to textured protein weight ratio of about 3:1 to about 7:1, wherein the meat base composition has a full amino acid profile, wherein all components of the composition are plant-based, and wherein the meat base composition has a meat-like texture and appearance.

2. The meat base composition of claim 1, wherein the starch binder comprises cooked rice.

3. The meat base composition of claim 1, wherein a weight ratio of starch binder to water is at least 1:30.

4. The meat base composition of claim 1, comprising at least about 2 wt. % starch binder.

5. The meat base composition of claim 1, comprising about 1-3 wt. % coloring agent.

6. The meat base composition of claim 1, wherein the coloring agent comprises beet root powder.

7. The meat base composition of claim 1, comprising about 5-15 wt. % textured protein.

8. The meat base composition of claim 1, wherein the textured protein is textured soy protein.

9. A food composition, comprising:
a meat base composition of claim 1; and
at least one additional component that adds flavor and/or aroma to the food composition.

10. The food composition of claim 9, comprising about 70-80 wt. % meat base composition.

11. The food composition of claim 9, wherein the meat base composition is configured to impart a meat-like property to the food composition.

12. The food composition of claim 9, having a nutritional profile that provides a complete and balanced petfood diet as defined by Association of American Feed Control Officials.

13. The food composition of claim 9, having an amino acid profile comprising essential amino acids.

14. The food composition of claim 9, comprising at least one additional protein.

15. The food composition of claim 14, wherein the at least one additional protein comprises at least one of yeast protein or pea protein.

16. The food composition of claim 15, comprising about 5-10 wt. % yeast protein.

17. The food composition of claim 15, comprising about 1-5 wt. % pea protein.

18. The food composition of claim 15, comprising both yeast protein and pea protein, wherein a weight ratio of the yeast protein to the pea protein is from about 5:2 to about 3:1.

19. The food composition of claim 15, comprising both yeast protein and pea protein, wherein a weight ratio of the textured protein to a total amount of the yeast protein and the pea protein is from about 1:1 to about 3:2.

20. The food composition of claim 9, comprising at least one additional source of essential vitamins, essential minerals, or a combination thereof.

21. The food composition of claim 9, comprising at least one additional fiber source.

22. The food composition of claim 9, comprising at least one additional antioxidant and/or preservative.

23. The food composition of claim 9, wherein the food composition is a petfood composition.

24. The food composition of claim 9, wherein the food composition has a shelf-life of about 3-10 days refrigerated.

25. A method of making a plant-based food composition, comprising:
mixing water, coloring agent, a starch binder, and textured soy protein to form meat base;
mixing in additional plant-based protein;
mixing in palatant;
mixing in vitamins and minerals;
mixing in oil and preservative.

26. The method of claim 25, further comprising mixing in flavoring agent.

27. The method of claim 25, further comprising setting aside the food composition under controlled temperature for further hydration.

28. The method of claim 25, further comprising cooking the composition to remove about 60 wt. % to about 90 wt. % water from the composition.

29. A dehydrated plant-based food composition, comprising:
a textured protein;
a starch binder;
water;
optionally a coloring agent; and
at least one additional component that adds flavor and/or aroma to the food composition;
wherein the weight percentage of water in the composition is no more than 30%;
wherein the composition has a full amino acid profile;
wherein all components of the composition are plant-based;
and when the composition is rehydrated, the composition has a meat-like texture and appearance.

30. A dehydrated plant-based food composition, prepared by cooking the plant-based food composition of claim 9 to remove about 60 wt. % to about 90 wt. % water from the plant-based food composition.
